(19) United States
(12) Patent Application Publication
(10) Pub. No.: US 2012/0023013 A1
(43) Pub. Date: Jan. 26, 2012

(54) NONPROFIT ORGANIZATION RESIDUAL MERCHANT ACCOUNT CONTRIBUTION SYSTEM AND METHOD

(76) Inventor: James E. Holcomb, Lebanon, TN (US)

(21) Appl. No.: 13/247,730

(22) Filed: Sep. 28, 2011

Related U.S. Application Data
(63) Continuation of application No. 12/082,700, filed on Apr. 11, 2008, now abandoned.
(60) Provisional application No. 60/923,664, filed on Apr. 16, 2007.

(51) Int. Cl. G06Q 40/00

(52) U.S. Cl. 705/39; 705/329

(57) ABSTRACT

A system and method whereby certain nonprofit entities and/or their business contributors may recover portions of certain fees currently being paid in the normal and regular in their course of doing business. These recovered fees may then be used as essentially automatic contributions to qualified IRS 501(c)(3) organizations, or public charities described in Internal Revenue Code Section 509, or agencies which operate for the public good (e.g., disaster relief, homeless shelters, support groups such as booster clubs, etc.) (such eleemosynary organizations all being referred to herein generally just as non-profit entities). This system and method is termed “Non-profit Organization Residual Merchant Account Contribution” (NORMAC).

### CROSS REFERENCE TO RELATED APPLICATIONS

The present application is a continuation of U.S. patent application Ser. No. 12/082,700 filed on Apr. 11, 2008 which is a non-provisional U.S. Provisional Application No. 60/923,664 filed on Apr. 16, 2007. The entire disclosure contents of these applications are herewith incorporated by reference into the present application.

### FIELD OF THE INVENTION

This invention relates to a system and method for an entity to recover at least portions of certain transactional fees that are typically being paid in the course of doing business, and in particular fees associated with electronic funds transactions (EFT). These recovered fees are then most preferably used as contributions to qualified 501(c)(3) organizations as specified within the IRS Code.

### BACKGROUND

Predetermined selected credit card merchant accounts are normally under an individually assigned agreement, either directly or indirectly, through a registered independent service organization (ISO). The ISO provides credit card processing to businesses, merchants, individuals and the like, using electronic funds transfer (EFT) methods and techniques involved in the normal procedure of merchant account credit card processing. An agreement between the processing entity and the merchant is valid for a specified period of time or until it is canceled by either party under the terms of such agreement.

A transaction, which may be a contribution as to a non-profit entity, typically occurs when the merchant receives payment from a customer or the nonprofit organization receives a contribution from a contributor which is received via EFT methods. The merchant or the nonprofit organization uses existing EFT methods to capture (e.g., log, accept, receive) a transaction or contribution, typically by means of ubiquitous software programs used to this end (which could be resident on an Internet webpage, a hardware terminal device present and connected to the Internet, or via modem using an analog telephone line). A customer or contributor may, for example, enter into the transaction by using a credit card data entry. The transaction processing entity (merchant processor) provides the service of advance guarantee of payment to the merchant or to the nonprofit organization of the payment or contribution being transferred by EFT methods. The merchant or nonprofit organization receives the transaction funds via EFT within a designated time period, as stated in the agreement, immediately following the time of the transaction or contribution. This process continues for a designated period of time, normally and usually thirty (30) days, at which time the merchant or nonprofit organization pays the merchant processor the designated agreed upon fees via EFT as regulated by the Interchange rates which are based on various merchant factors, such as: volume tiered pricing, SIC code and transaction size qualifications, compliance requirements, registration requirements, and/or merchant risk level. These fees are broken down into various costs as determined by the credit card industry.

The revenue profit (that portion of fees collected that are above costs) is referred to as a residual profit, as it is a remaining amount above costs and continues monthly for the life of the agreement. The residual profit is then distributed between the designated parties involved in the processing sequence, including but not limited to the merchant processor and/or the ISO and/or the MLS. The residual profit cycle continues over time, while the value of the residual fluctuates with regard to normal industry practices, credit card volume of the account, costs incurred while maintaining the account, the risk of the account, terms of the contract, and other items dependent upon the processing requirements of the processor of the predetermined selected credit card merchant account(s).

It is this residual profit (or a portion of it) that is the source of funds upon which this invention operates.

### SUMMARY

It is a particular objective of the invention to create a system and method whereby certain nonprofit entities and/or their business contributors may recover portions of certain fees currently being paid in the normal and regular in their course of doing business. These recovered fees may then be used as essentially automatic contributions to qualified IRS 501(c)(3) organizations, or public charities described in Internal Revenue Code Section 509, or agencies which operate for the public good (e.g., disaster relief, homeless shelters, support groups such as booster clubs, etc.) (such eleemosynary organizations all being referred to herein generally just as non-profit entities).

For purposes contained herein, this system and method is termed “Non-profit Organization Residual Merchant Account Contribution” (NORMAC). NORMAC applies new methodology to existing electronic funds transfer (EFT) methods and techniques involved in the normal procedure of merchant account credit card processing in order to generate funds for these non-profit entities in a very benign manner.

The invention in its preferred form automatically captures and redirects residual funds that portion of the processing fees (now earmarked as a charitable contribution) above costs as a contribution to a designated non-profit entity contribution fund in the normal procedure of credit card processing merchant account operation(s). These funds are derived during the normal processing procedure being used, with NORMAC being executed by predetermined selected credit card merchant account(s), of either pre-existing or new credit card processing merchant account operation(s), sourced out of all or a portion (now earmarked as a charitable contribution) of the normal revenue profit of that specified predetermined selected credit card merchant account(s).

These and other advantages, benefits and objectives of the invention will be further understood upon consideration of the following detailed description of embodiments of the invention taken in conjunction with the drawings, in which:

### BRIEF DESCRIPTION OF THE FIGURES

FIG. 1 is a flow diagram of a NORMAC transaction where the processing results in a contribution to a designated non-profit entity; and

FIG. 2 is a flow diagram of a NORMAC transaction where the processing results in a contribution to a designated non-profit entity, or to the originating transaction processing non-profit entity.

### DETAILED DESCRIPTION

The NORMAC system and method is a process which isolates all, or at least a portion of the residual revenue profit (defined as that portion of the fees that is over and above costs) of the processing fees of a predetermined selected credit card merchant account, being transferred using EFT methods. Of course, there can be applications of the invention not using EFT methods, but the most preferred application is in the context of EFT.

NORMAC enables a portion of the revenue profit of the normal fees, regularly paid to a credit card processor by a business entity or by a nonprofit organization, to become a designated charitable contribution (therein returning the same accounting rights of this portion of the fee to and in control of the originating entity, now earmarked as a charitable contribution).

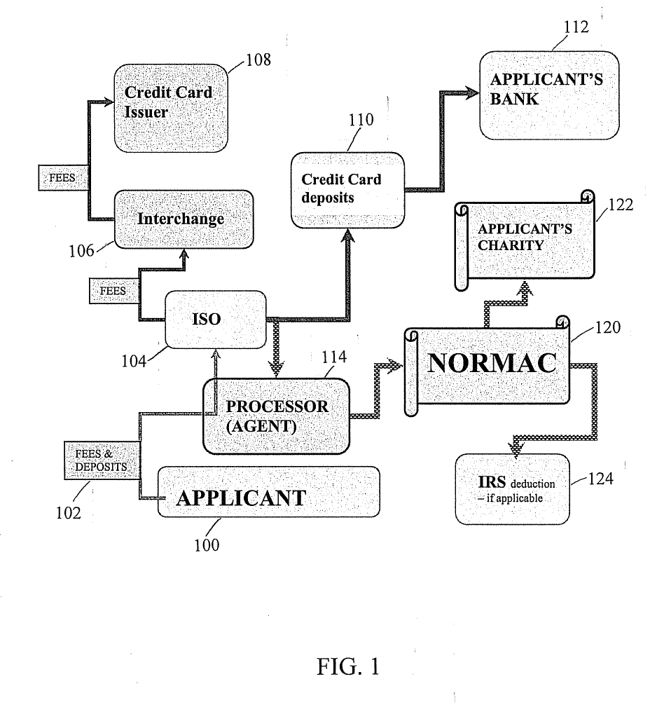

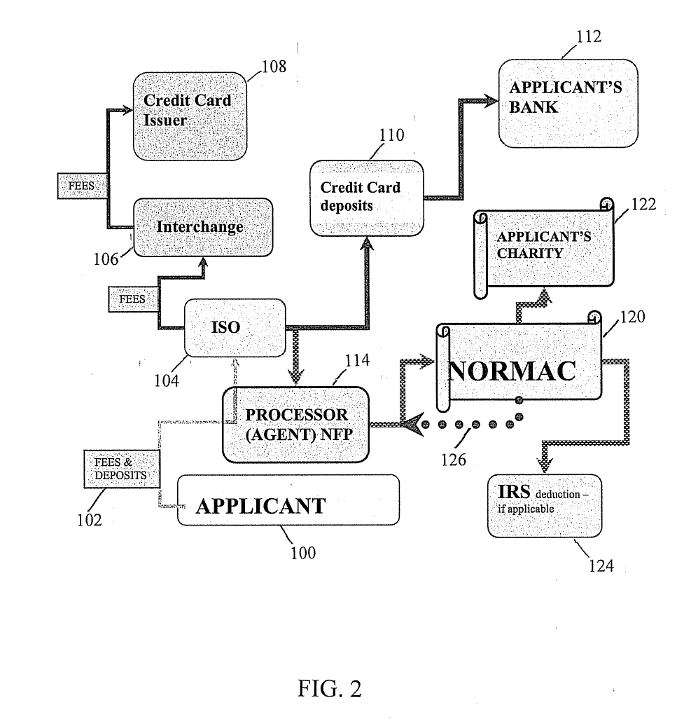

NORMAC in one embodiment involves the initial formation of a corporate entity (for purposes of this application we shall call this entity the “Processor”) which operates as either a for-profit organization (see FIG. 1) or a nonprofit organization (see FIG. 2). This entity would be registered with the Internal Revenue Service and/or particular State Agencies governing its function. The Processor acts (by assigned agreement) in a fiduciary manner as either: a) a registered credit card processing ISO or b) MLS of the registered ISO by written agreement(s), or c) top-level processor/card issuer; with a retail merchant or non-profit organization (for purposes of application we shall call either of these entities the “Applicant”). The Processor operates within applicable Federal and State guidelines.

The Processor acts either as the top level processor, the bankcard issuer, the registered ISO or as the agent for the registered ISO, in relationship with the Applicant. This NORMAC method can be best facilitated, either through the credit card sponsoring Bank (or other card issuing entity), the registered ISO, or the agent of the ISO, through the revenue profit portion of the processing fees associated with transactions or contributions that occur via EFT methods.

Referring now to FIG. 1 in particular, if the Processor is a for-profit entity, NORMAC takes the residual profit portion and, via EFT or check, contributes that portion to any qualified and registered nonprofit organization or its designate (to be predetermined by the Applicant via agreement).

Applicant is indicated at 100, and generates fees and deposits 102. These go through the ISO 104, where fees are ultimately routed through an Interchange step 106, with fees being allocated to the Credit Card Issuer 108.

Credit card deposits 110 are likewise processed through the ISO, ultimately residing in Applicant's Bank 112 (or similar repository from which funds can be deposited, and/or withdrawn).

The Processor (Agent) 114, which can also be the top level processor, the bankcard issuer, or the ISO itself (as noted above), is the point where the residual profit portion of the transaction fee process is acted upon by the NORMAC system and method, indicated at 120. A portion of or all of the now-NORMAC residual revenue profit is contributed to a predetermined non-profit entity 122. An IRS deduction 124, if applicable, can also be registered at the same time.

Referring now to FIG. 2 in particular, it will be noted that it is identical to the process of FIG. 1 in all respects, except for the optional step indicated at 126. Here, if the Processor 114 is also a non-profit entity, the NORMAC may be either retained or distributed by the nonprofit Processor 114 (to be predetermined by the Applicant via agreement). In the case of the NORMAC residual being designated to and retained by the Processor (being a for-profit entity), the NORMAC residual is contributed/distributed by the Processor incrementally in time intervals as stated by agreement, and shall continue for the duration of that agreement. In the case of the NORMAC being designated to and retained by the Processor (being a nonprofit entity), the Processor shall have full rights and use (within the scope, as specified in its bylaws or charter, of its stated specific purpose or mission statement) of the NORMAC residual as it becomes available during the normal course of merchant account processing. The immediate or interval NORMAC residual would be surrendered to the Processor for its sole use in the event that the agreement was cancelled or made void, by the Applicant or the Processor, prior to the originally stated term of the agreement.

In this way, business entities, under agreements with the Processor, which currently are contributors to designated nonprofit organization(s), can automatically assign the NORMAC residual to be transferred via EFT or check to their designated, qualified nonprofit organization (or to itself, in the event the residual is from the very same nonprofit entity). The NORMAC shall be activated (deposited into the valid, pre-authorized bank account of the designated nonprofit organization) in accordance with the terms of the agreement with the Processor. It is anticipated that the Processor would issue a receipt in the amount of the NORMAC residual to the Applicant on a specific date which shall be set forth and predetermined by agreement, to be used for accounting/tax purposes of the Applicant.

Nonprofit organizations that utilize EFT methods in order to receive/deliver contributions shall be facilitated by the NORMAC system and method. The availability and methodology of EFT processing for the nonprofit community today differs dramatically. While some EFT processors offer free or discounted software and other needed services to their non-profit customers, the funds transfer costs that are offered are usually much more than costs and vary widely with regard to monthly fees or setup fees. For the nonprofit organization community, the usefulness of the NORMAC system and method elucidates a long existing quandary for the non-profit organizational community of having to decide whether or not to accept EFT as a means of contribution delivery because of the fees involved. The nonprofit community realizes that the fees associated with providing the EFT delivery method to its contributors shall create, by process, a decrease in the amount of the contribution. The majority of the nonprofit community is constantly trying to achieve self-sufficiency while struggling to maintain a sustainable environment. The NORMAC system and method assists the nonprofit community by aiding to create a level of sustainability which facilitates the focus of a nonprofit to be primarily on their mission of purpose rather than focusing on their accumulation of financial resources (fundraising). The most important element of a nonprofit organization's business plan is the ability to focus on their mission statement. The NORMAC method lends itself to this focus of mission within the nonprofit community.

So too, business entities that may or may not regularly contribute to nonprofit organizations shall be aided by the NORMAC system and method. The National Center for Charitable Statistics at the Urban Institute has shown that while the nation's gross domestic product grew by an inflation-adjusted 36.6 percent from 1994 to 2004, the nonprofit sector's revenues increased 61.5 percent. Private foundations provide grant funds which are primarily derived from the contributions or endowments originating from for-profit business organizations or corporations. The NORMAC system and method provides an additional incentive to corporate America to continue increasing its level of generous commitment by providing a method whereby a corporation shall increase that level of commitment without creating a decrease in their cash flow. NORMAC is well positioned within the scope of the business model of corporate America as a method that secures itself naturally to the corporate environment of philanthropy and also becomes an obvious integrated component of the normal process of that philanthropy.

Thus, while the invention has been described in relationship to certain presently preferred embodiments, those of skill in the art will recognize changes and modifications that will still fall within the scope of the invention, as defined by the following claims.

1. A method for allocating funds in processing electronic fund transfers comprising the steps of:
establishing a standard written merchant processing agreement between a business merchant and a processing entity engaged in processing merchant credit card-based fund transactions, resulting in processing fees;
determining with a computer (i) a portion of a residual revenue profit of the processing fees of a predetermined selected credit card merchant account and (ii) automatically using EFT system interchange, then;
allocating said amount to a designated non-profit entity; and
registering a deposit of said amount into an account for use by said designated entity.

2. The method of claim 1 wherein a processor of said processing fees is said designated entity.

3. The method of claim 1 wherein said processing entity is a bank card issuer or top level processor, a registered credit card processing ISO or the MLS of the registered ISO, and said processing entity operates independently as to selection of the designated entity.

4. The method of claim 1 wherein a processor of said processing fees is said designated non-profit entity.

5. The method of claim 1 wherein said designated non-profit entity is a charitable institution.
